(19) United States
(12) Patent Application Publication
(10) Pub. No.: US 2008/0222416 A1
(43) Pub. Date: Sep. 11, 2008

(54) Secure Network Connection

(76) Inventors: Gary Kiwimagi, Greeley, CO (US); Luke M. Norris, Loveland, CO (US); Charles McJilton, Longmont, CO (US)

Correspondence Address: BERENBAUM, WEINSHIENK & EASON, P.C, 370 17TH STREET, SUITE 4800, DENVER, CO, 80202, US

(21) Appl. No.: 12/037,905

(22) Filed: Feb. 26, 2008

Related U.S. Application Data
(63) Continuation of application No. 10/726,231, filed on Dec. 1, 2003, now abandoned.

(51) Int. Cl. H04L 9/32

(52) U.S. Cl. 713/171; 726/5

(57) ABSTRACT

Implementations described and claimed herein provide a secure network connection for remote access, e.g., to building automation systems. A secure network connection may be established according to one implementation between a remote client and a system host for the building automation system. The system host provides its network address to a security host. When the remote client desires access to the system host, the remote client requests the network address from the security host. The security host authenticates the remote client as an authorized user. If the remote client is an authorized user, the security host provides the network address and a security key to the remote client. The remote client then uses the network address to request access to the system host. The system host authenticates the remote client by requesting the security host to verify the security key before granting the remote client access to the system host.

### TECHNICAL FIELD

The described subject matter relates to networks for electronic computing, and more particularly to systems and methods of establishing secure network connections for electronic computing systems.

### BACKGROUND

The ability to automatically control one or more functions in a building (e.g., lighting, heating, air conditioning, security systems) is known as building automation. Building automation systems may be used, for example, to automatically operate various lighting schemes in a house. Of course building automation systems may be used to control any of a wide variety of other functions, more or less elaborate than controlling lighting schemes.

It is often desirable to remotely access the building automation system to monitor and/or change various functions of the building automation system. For example, a homeowner planning to return home from a vacation earlier than initially expected may want to change the building automation system from a vacation mode to an “every-day” mode prior to the occupants returning home. In another example, an integrator may be responsible for installing and/or maintaining automation systems for a number of customers and may want to remotely access a customer's automation system to assist the customer. These examples are merely illustrations of two types of remote access that may be desired as there are others too numerous to discuss.

Building automation systems may be remotely accessed via networks such as the Internet or telephone networks. However, providing remote access over a public communication network also makes the building automation system vulnerable to unauthorized access, e.g., by hackers. It is therefore desirable to provide remote access via a secure connection.

### SUMMARY

Implementations described and claimed herein provide access, e.g., to building automation systems, via a secure network connection. A secure network connection may be established in a network environment according to one implementation between a remote client and a system host for the building automation system. The system host provides its network address to a security host. When the remote client desires access to the system host, the remote client requests the network address from the security host. The security host authenticates the remote client as an authorized user. If the remote client is an authorized user, the security host provides the network address and a security key to the remote client. The remote client then uses the network address to request access to the system host. The system host authenticates the remote client by requesting the security host to verify the security key before granting the remote client access to the system host.

In some implementations, articles of manufacture are provided as computer program products. One implementation of a computer program product provides a computer program storage medium readable by a computer system and encoding a computer program for version enforcement. Another implementation of a computer program product may be provided in a computer data signal embodied in a carrier wave by a computing system and encoding the computer program to establish a secure network connection.

The computer program product encodes a computer program for executing on a computer system a computer process that provides a network address for a system host to a remote client if security credentials for the remote client satisfy at least one condition for accessing the system host, and verifies the remote client is authorized to access the system host in response to a request from the system host to verify the remote client.

In another implementation, a method is provided. The method may be implemented to provide a network address for a system host to a remote client if security credentials for the remote client satisfy at least one condition for accessing the system host. The remote client is later verified as being authorized to access the system host in response to a request from the system host to verify the remote client

In yet another implementation, a system is provided including an authorization module receiving a request from a remote client to access a system host, the authorization module provides the remote client with a network address of the system host if the remote client is authorized to access the system host. A verification module receives a request from the system host to verify that the remote client is authorized to access the system host before granting the remote client access to the system host.

### BRIEF DESCRIPTION OF THE DRAWINGS

FIG. 1 is a schematic illustration of an exemplary network for establishing a secure connection;

FIG. 2 is a schematic illustration showing an exemplary implementation of computer systems that can be securely connected over a network;

FIGS. 3(a) and (b) illustrate an exemplary implementation of establishing a secure connection over a network;

FIG. 4 is a flowchart illustrating exemplary operations that may be implemented to establish a secure network connection; and

FIG. 5 is a schematic illustration of an exemplary computing device that can be utilized to establish a secure network connection.

### DETAILED DESCRIPTION

A user may desire to connect to a building automation system to access various automation functions (e.g., lighting, security, and climate controls) for the building. In one example, a homeowner may visit an Internet cafe while on vacation and access his or her home automation system to monitor security or adjust the thermostat prior to returning home. In another example, an integrator may use a desktop or laptop computer to access a customer's automation system to assist the customer with an automation function (e.g., to change a lighting or climate control scheme). Of course remote access to the building automation system may be desired for any of a wide variety of other reasons as well.

Configuration/monitoring software (e.g., a web application) may be provided via a server computer so that the user can use any available computer with a network connection. Alternatively, the integrator's laptop may have the configuration/monitoring software installed.

Access to the building automation system is preferably established via a secure network connection. Briefly, a secure network connection may be established in a network environment according to one implementation between a remote client, such as the integrator's laptop PC, and a system host provided with the building automation system.

Although exemplary implementations are described herein with reference to building automation systems, it should be understood that the scope is not limited to use with building automation systems and the invention may also find application in a number of different types of network systems now known or later developed.

Exemplary Architecture

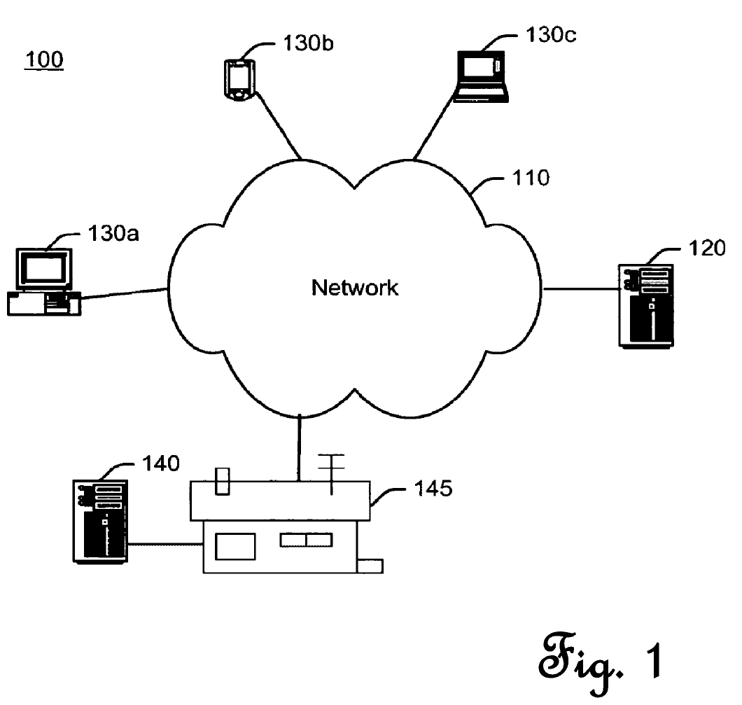

FIG. 1 is a schematic illustration of an exemplary networked computing system 100 in which a secure network connection may be established according to one implementation. The networked computer system 100 may include one or more communication networks 110, such as a local area network (LAN) and/or wide area network (WAN). A security host 120 may be provided to facilitate a secure connection between one or more remote clients 130a, 130b, 130c (hereinafter, generally referred to as 130) and a system host 140 (e.g., implemented in a building automation system at building 145).

As used herein, the term “host” is used to refer to both the security host 120 and the system host 140. The term “host” refers to the hardware and software (the entire computer system) used to perform various network services. A host may include one or more computing systems, such as a server, that also runs other applications or, it may refer to a computing system dedicated only to server applications. A host connects to a network via a communication connection, such as a dial-up, cable, or DSL connection via an Internet service provider (ISP).

A host may provide services to other computing or data processing systems or devices. For example, system host 140 may be implemented as a server computer to start processes in a building automation system. System host 140 may also provide other services, such as Internet and email services. Security host 120 may also be implemented as a server computer and may broker security and optionally provide control software to the remote client, as will be discussed in more detail below.

As used herein, the term “remote client” refers to the hardware and software (the entire computer system) used to perform various computing services. A client may include a computing system(s), such as a stand-alone personal desktop or laptop computer (PC), workstation, personal digital assistant (PDA), or appliance, to name only a few. A remote client also connects to a network via a communication connection, such as a dial-up, cable, or DSL connection via an Internet service provider (ISP) or may connect directly into a LAN, e.g., for the building automation system via network connection.

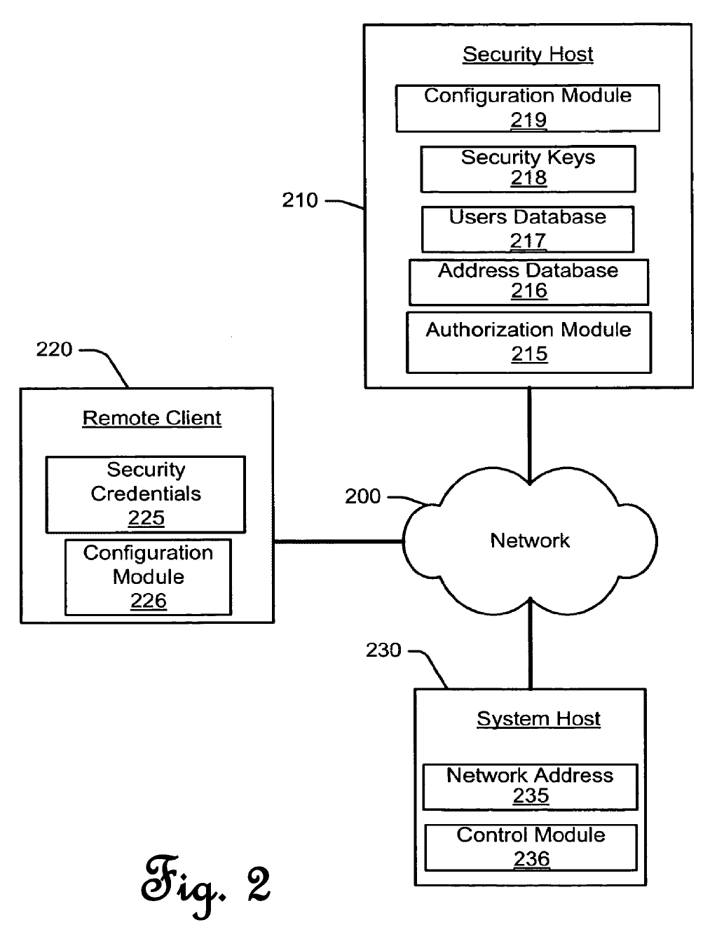

FIG. 2 is a schematic illustration showing an exemplary implementation of computer systems that can be connected on a network. According to this implementation, a security host 210 may facilitate a secure connection over a network 200 between a remote client 220 and a system host 230. Security host 210 may be implemented in a server computer, for example, at the office of the building automation system provider. System host 230 may also be implemented in a server computer, for example, as part of a building automation system. Remote client 220 may be implemented in a laptop or desktop computer, or in any other suitable device which is capable of establishing a network connection and sending and/or receiving data over that network connection (e.g., a PDA or mobile phone).

Security host 210 may be provided to broker security for the network connection, and optionally to provide software to the remote client once a network connection is established. Security host 210 may include an authorization module 215 which may be implemented to broker security for the system host 230. In one implementation, authorization module 215 has access to an address database 216, a user database 217, and one or more security keys 218.

Address database 216 includes the network address(es) for one or more system hosts 230 and may be provided by the security host 210 to a remote client 220 upon authenticating the remote client. The network address may be any address that identifies a system host 230 on a network 200. By way of example, the network address may include an Internet Protocol (IP) address, although higher level addresses (e.g., a domain name) may also be used in other implementations. Address database 216 may also include other information, such as users authorized to access a system host, time during which a system host may be accessed, and functions that may be accessed and/or modified via a remote access session, to name only a few.

User database 217 includes the identity of one or more remote clients 220 that are authorized to access the system host 230, and may optionally include one or more conditions the remote client 220 must satisfy before being authenticated by the security host 210. The user database 217 may include data in any format that identifies a remote client 220 as authorized to access one or more system hosts 230. For example, the identity of the remote client 220 may be a userID and the condition that must be satisfied by the remote client may be a password. User database 217 may also include other information that can be used to authenticate a user to the security host 210. User database 217 may also be updated to add and remove authorized users.

Security keys 218 may be provided to a remote client 220 that has been authenticated by the security host 210. In one implementation, security keys 218 are provided as an encrypted data packet, although other implementations are also possible. Security keys 218 may be unique for one or more system hosts, or the security keys 218 may be generic (i.e., used with any system hosts). Security keys 218 may also identify permissions (e.g., different levels of permitted access) for the remote client 220. In another implementation, security keys 218 may also include a time-stamp or an expiration time indicating a time during which the security keys 218 are valid.

System host 230 may be provided as part of a building automation system and may be used to monitor the status of the building automation system, serve as a central repository for program code that controls the various building automation devices, and administer various automation functions, to name only a few functions of the system host 230. System host 230 may also be accessed for remote control and/or monitoring of the building automation system, e.g., by remote client 220.

As discussed above, system host 230 may be identified on the network by a network address 235. System host 230 provides its network address 235 to the security host 210 so that the system host 230 can be identified on the network, e.g., by the remote client 220.

System host 230 may also include a control module 236. Control module 236 may be implemented, for example, as software to configure, monitor, and/or control various functions in the building automation system. When the remote client 220 accesses the system host 230, remote client 220 establishes a communications link (e.g., via a software interface) with the control module 236 to remotely configure, monitor, and/or control various functions in the building automation system.

Remote client 220 may be used by a homeowner, integrator, or other user to access the system host 230. Remote client 220 may include security credentials 225 for authenticating the remote client 220 to the security host 210. Remote client 220 may also include a configuration module 226.

Configuration module may be implemented as program code (e.g., software) for interfacing with the control module 236 at the system host when the remote client 220 has established a secure network connection to the system host 230. In an alternative embodiment, configuration module 219 may be provided via the security host 210 (e.g., as a web-enabled application).

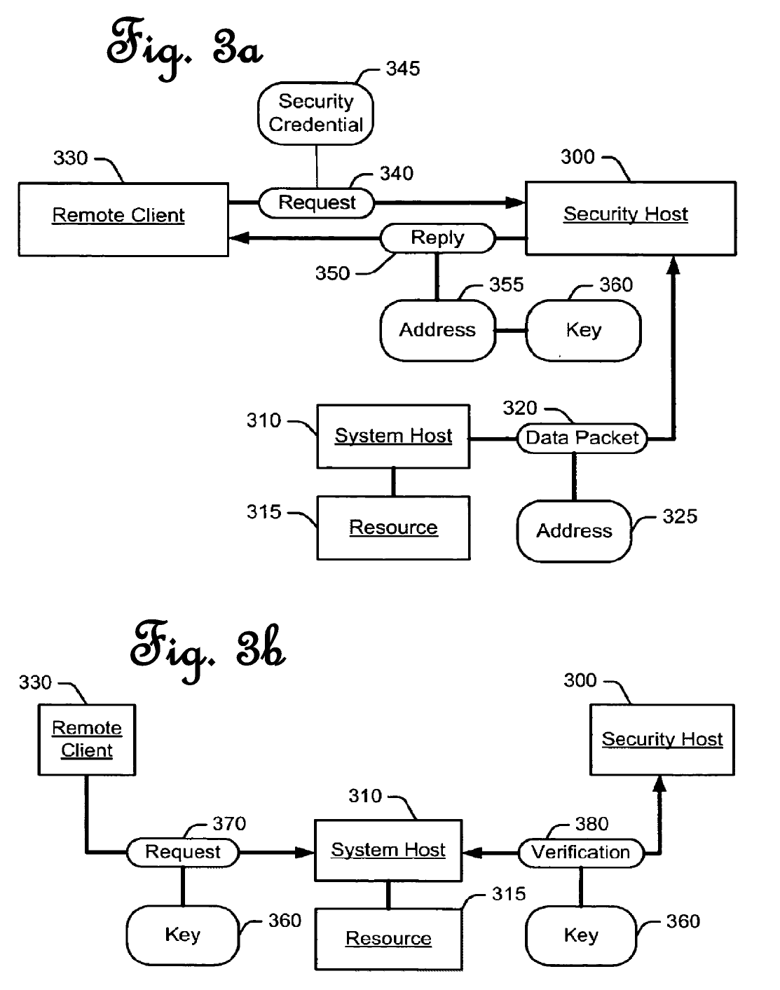

FIGS. 3(a) and (b) illustrate an exemplary implementation of establishing a secure network connection. Referring to FIG. 3(a), security host 300 receives the network address for system host 310. For example, system host 310 may “ping” the security host 300 with a data packet 320 containing at least the network address 325 of the system host 310.

If security host 300 is responsible for managing access to more than one system host 310, the data packet 320 may also include the identity of the corresponding system host 310. Security host 300 maintains the network address 325 and corresponding identity of the system host 310 (e.g., in the address database 216 in FIG. 2).

When a remote client 330 desires access to system host 310, the remote client 330 sends a request 340 to the security host 300. Request 340 may include security credentials 345 for the remote client 330. In one exemplary embodiment, the security credentials 345 include a user login and password to authenticate the remote client 330 to the system host 300. However, other security credentials may also be used in addition to or instead of user login and password.

The security host 300 determines whether the remote client 330 is authorized to access the system host 310. In one implementation, the security host 300 evaluates the security credentials 345 provided by the remote client based on one or more conditions for accessing the system host 310. If the security credentials do not satisfy the conditions for accessing the system host 310, the remote client 330 is denied access. For example, the security host 300 may return a message indicating to the user at the remote client 330 that access is denied. Optionally the security host 300 may prompt the remote client 330 to try again (e.g., provide a different password).

If the security host 300 determines that the remote client 330 is authorized to access the system host 310 (e.g., the security credentials satisfy the conditions for accessing the system host), the security host 300 provides the network address 355 of the system host 310 to the remote client 330. Optionally, the security host 300 also provides the remote client 330 with a security key 360.

Referring now to FIG. 3(b), the remote client 330, having been authenticated by the security host 300, sends a request 370 for access to the system host 310 using the network address 355 provided to by the security host 300 in FIG. 3(a). Optionally, the remote client 330 also provides the security key 360 to the system host 310.

The system host 310 may further authenticate the remote client 330 before granting access. In one implementation, system host 310 sends a verification request 380 to the security host 300. The verification request 380 may include the identity of the remote client, and optionally, also includes the security key 360 provided by the remote client 330. The security host 300 evaluates the verification request 380, and optionally the security key 360 to determine whether the remote client 330 is indeed authorized to access the system host 310. If the security host 300 determines that the remote client 330 is authorized and has provided a valid security key 360 to the system host 310, the security host 300 returns verification to the system host 310 that the remote client 330 is authorized to access the system host 310. In turn, the system host 310 grants access to the remote client 330. For example, the remote client 330 can now monitor and/or control various functions of the building automation system.

Exemplary Operations

Described herein are exemplary methods for implementing remote access to a building automation system via a secure network connection. The methods described herein may be embodied as logic instructions on one or more computer-readable medium. When executed on a processor, the logic instructions cause a general purpose computing device to be programmed as a special-purpose machine that implements the described methods. In the following exemplary operations, the components and connections depicted in the figures may be used to implement a secure network connection.

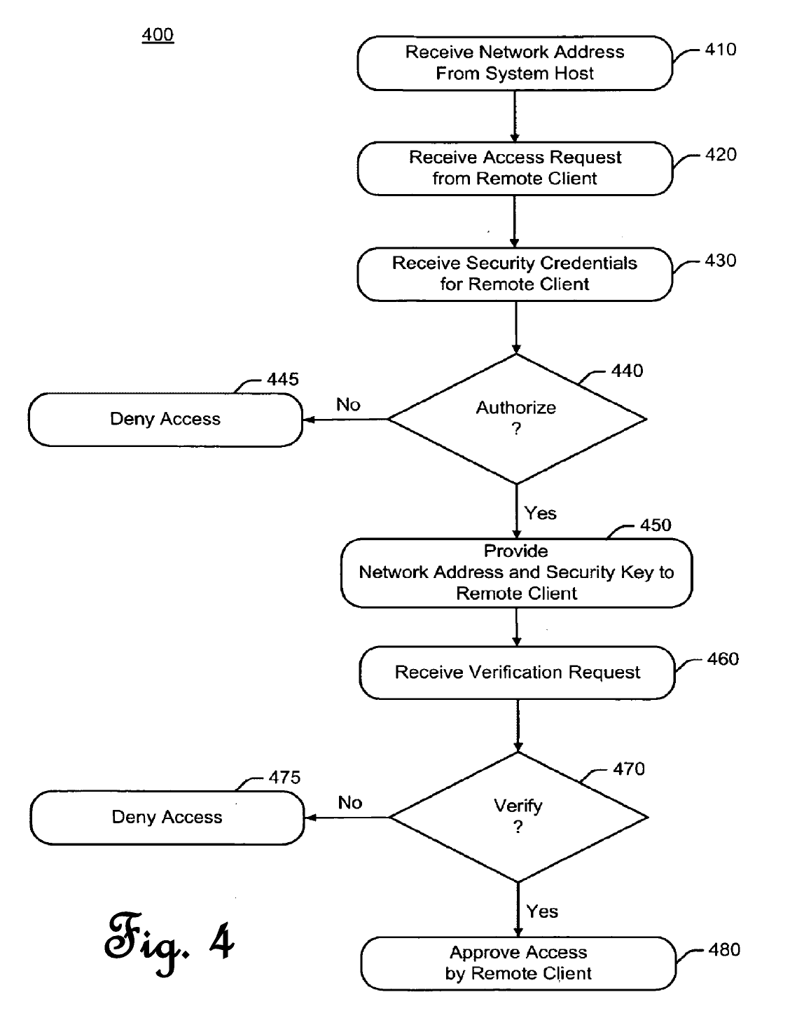

FIG. 4 is a flowchart illustrating exemplary operations 400 as the operations may be implemented by a security host to establish a secure network connection (e.g., between a remote client and a system host). In operation 410, a network address for the system host is received (e.g., by a security host). In operation 420, an access request is received from a remote client. In operation 430, security credentials may be received for the remote client. The security credentials may be provided by the remote client.

In operation 440, a determination is made whether the remote client is authorized to access the system host. Operation 445 denies the remote client access to the system host if the remote client is not authorized. For example, the security host may deny access by not providing the network address of the system host to the remote client and/or by not providing the security key.

Alternatively, in operation 450, the network address and security key(s) are provided to the remote client. The remote client may use the network address to request access to the system host. The remote client may also use the security key(s) to identify the remote client as being authorized by the security host to access the system host. Before granting access to the remote client, the system host queries the security host to verify that the remote client is indeed authorized for access to the system host. In operation 460 a verification request from the system host is received, e.g., at the security host.

In operation 470, a determination is made whether access by the remote client is authorized. If it is determined that the remote client is not authorized to access the system host, access is denied in operation 475. For example, if the key has expired or been tampered with, the security host denies access to the system host.

Alternatively, the security host authorizes access to the system host in operation 480 (e.g., if the security key presented by the remote client is valid). The security host approves access to the system host by the remote client. Accordingly, a secure and authenticated peer to peer connection may be established over the network between the remote client and the system host.

Exemplary Computing Device

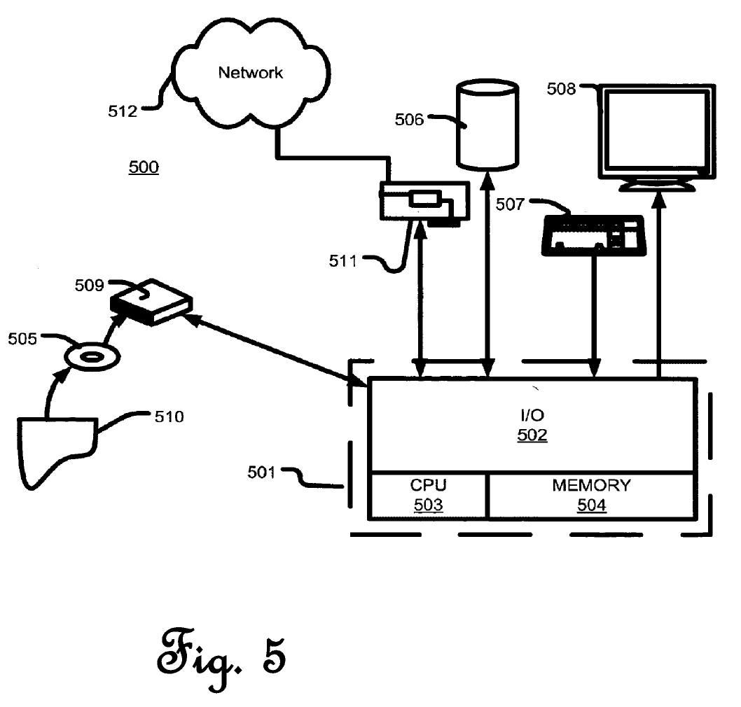

FIG. 5 depicts an exemplary general purpose computer 500 capable of executing a program product and establishing a secure network connection. In such a system, data and program files may be input to the computer, including without limitation by removable or non-removable storage media or a data signal propagated on a carrier wave (e.g., data packets over a network). The computer 500 may be a conventional computer, a distributed computer, or any other type of computing device.

The computer 500 can read data and program files, and execute the programs and access the data stored in the files. Some of the elements of an exemplary general purpose computer are shown in FIG. 5, including a processor 501 having an input/output (I/O) section 502, at least one processing unit 503 (e.g., a microprocessor or microcontroller), and a memory section 504. The memory section 504 may also be referred to as simply memory, and may include without limitation read only memory (ROM) and random access memory (RAM).

A basic input/output system (BIOS), containing the basic routines that help to transfer information between elements within the computer 500, such as during start-up, may be stored in memory 504. The described computer program product may optionally be implemented in software modules loaded in memory 504 and/or stored on a configured CD-ROM 505 or other storage unit 506, thereby transforming the computer system in FIG. 5 to a special purpose machine for implementing the described system.

The I/O section 502 is connected to keyboard 507, display unit 508, disk storage unit 506, and disk drive unit 509, typically by means of a system or peripheral bus (not shown). The system bus may be any of several types of bus structures including a memory bus or memory controller, a peripheral bus, and a local bus using any of a variety of bus architectures.

Typically the disk drive unit 509 is a CD-ROM drive unit capable of reading the CD-ROM medium 505, which typically contains programs 510 and data. Computer program products containing mechanisms to effectuate the systems and methods in accordance with the present invention may reside in the memory section 504, on a disk storage unit 506, or on the CD-ROM medium 505 of such a system. Alternatively, disk drive unit 509 may be replaced or supplemented by a floppy drive unit, a tape drive unit, or other storage medium drive unit. The network adapter 511 is capable of connecting the computer system to a network 512. In accordance with the present invention, software instructions directed toward accepting and relaying access information (e.g., authentication and security data) may be executed by CPU 503, and databases may be stored on disk storage unit 506, disk drive unit 509 or other storage medium units coupled to the system.

The drives and their associated computer-readable media provide nonvolatile storage of computer-readable instructions, data structures, program modules and other data for the computer 500. It should be appreciated by those skilled in the art that any type of computer-readable media which can store data that is accessible by a computer, such as magnetic cassettes, flash memory cards, digital video disks, Bernoulli cartridges, random access memories (RAMs), read only memories (ROMs), and the like, may be used in the exemplary operating environment.

The computer 500 may operate in a networked environment using logical connections to one or more remote computers. These logical connections are achieved by a communication device 511 (e.g., such as a network adapter or modem) coupled to or incorporated as a part of the computer 500. Of course the described system is not limited to a particular type of communications device. Exemplary logical connections include without limitation a local-area network (LAN) and a wide-area network (WAN). Such networking environments are commonplace in office networks, enterprise-wide computer networks, intranets and the Internal, which are all exemplary types of networks.

In addition to the specific implementations explicitly set forth herein, other aspects and implementations will be apparent to those skilled in the art from consideration of the specification disclosed herein. It is intended that the specification and illustrated implementations be considered as examples only, with a true scope and spirit of the following claims.

1. A method comprising:
receiving at a security host a request from a remote client to access a system host, the request including security credentials;
providing a network address for the system host to the remote client if the security credentials for the remote client satisfy at least one condition for accessing the system host;
following an attempt by the remote client to directly access the system host, receiving at the security host a request from the system host to verify that the remote client is authorized to access the system; and,
transmitting from the security host to the system host a verification, whereby the system host grants the remote client direct access to the system host.

2. The method of claim 1, further comprising:
transmitting from the security host to the remote client a security key with the network address if the security credentials for the remote client satisfy the at least one condition for accessing the system host; and
following an attempt by the remote client to directly access the system host, the attempt including a transmission of the security key, evaluating the security key when it is received by the security host from the system host to verify that the remote client is authorized to access the system host.

3. The method of claim 1, further comprising requiring the remote client present the system host with a valid security key to verify that the remote client is authorized to access the system host.

4. The method of claim 1, further comprising requiring the remote client timely present the system host with a security key to verify that the remote client is authorized to access the system host.

5. The method of claim 1, further comprising receiving at the security host the network address from the system host.

6. A computer program product encoding a computer program for executing on a computer system a computer process, the computer process comprising:
receiving at a security host a request from a remote client to access a system host, the request including security credentials;
providing a network address for the system host to the remote client if the security credentials for the remote client satisfy at least one condition for accessing the system host;
following an attempt by the remote client to directly access the system host, receiving at the security host a request from the system host to verify that the remote client is authorized to access the system; and,
transmitting from the security host to the system host a verification, whereby the system host grants the remote client direct access to the system host.

7. The computer program product of claim 6 wherein the computer process further comprises:
transmitting from the security host to the remote client a security key with the network address if the security credentials for the remote client satisfy the at least one condition for accessing the system host; and
following an attempt by the remote client to directly access the system host, the attempt including a transmission of the security key, evaluating the security key when it is received by the security host from the system host to verify that the remote client is authorized to access the system host.

8. The computer program product of claim 6 wherein the computer process further comprises requiring the remote client present the system host with a valid security key to verify that the remote client is authorized to access the system host.

9. The computer program product of claim 6 wherein the computer process further comprises requiring the remote client timely present the system host with a security key to verify that the remote client is authorized to access the system host.

10. The computer program product of claim 6 wherein the computer process further comprises at the security host-receiving the network address from the system host.

11. A security host comprising:
an authorization module receiving a request from a remote client to access a system host, the authorization module providing the remote client with a network address of the system host if the remote client is authorized to access the system host;
a verification module receiving a request from the system host to verify that the remote client is authorized to access the system host before granting the remote client access to the system host.

12. The security host of claim 11 further comprising a security key to be provided to the remote client if the remote client is authorized to access the system host.

13. The security host of claim 11 further comprising a security key to be provided to the remote client for presentation to the system host to verify that the remote client is authorized to access the system host.

14. The security host of claim 11 further comprising a security key to be provided to the remote client for timely presentation to the system host to verify that the remote client is authorized to access the system host.

15. The security host of claim 11 further comprising an address database having the network address of the system host.

16. The security host of claim 11 further comprising a configuration module for accessing a building automation system via the system host if the remote client is granted access to the system host.

17. The security host of claim 16 wherein the configuration module is provided at the remote client.

18. The security host of claim 16 wherein the configuration module is provided at a security host.

19. The security host of claim 16 wherein the configuration module is provided for the remote client via a security host.

20. The security host of claim 16 wherein the configuration module is provided by the security host for the remote client as a web application.
